(19) United States
(12) Patent Application Publication
(10) Pub. No.: US 2024/0185319 A1
(43) Pub. Date: Jun. 6, 2024

(54) DYNAMIC USER-ORIENTED VEHICLE SALES OPTIMIZATION METHODS AND SYSTEMS

(71) Applicant: Volvo Car Corporation, Göteborg (SE)

(72) Inventor: Douglas Robert Case, Saratoga, CA (US)

(21) Appl. No.: 18/529,009

(22) Filed: Dec. 5, 2023

Related U.S. Application Data
(60) Provisional application No. 63/430,368, filed on Dec. 6, 2022.

(51) Int. Cl. G06Q 30/0601

(52) U.S. Cl. CPC G06Q 30/0621; G06Q 30/0609; G06Q 30/0641

(57) ABSTRACT

Methods and systems for optimizing a user experience such that customers/users who are online looking to purchase or lease/subscribe/rent vehicles are presented UI/UX user flows defaulting to or otherwise favoring a vehicle model/version (and trim and color and add-ons) that are as optimal as possible for both the customer/user and for the vehicle manufacturer. These concepts may be extended beyond the automotive context as well.

### CROSS-REFERENCE TO RELATED APPLICATION

The present disclosure claims the benefit of priority of co-pending U.S. Provisional Patent Application No. 63/430,368, filed on Dec. 6, 2022, and entitled “DYNAMIC USER-ORIENTED VEHICLE SALES OPTIMIZATION METHODS AND SYSTEMS,” the contents of which are incorporated in full by reference herein.

### TECHNICAL FIELD

The present disclosure relates generally to methods and systems for optimizing a user vehicle sales, leasing, subscription, and/or rental user interface (UI) experience.

### BACKGROUND

Benefits can be provided to customers by improving their experience using a vehicle sales, leasing, subscription, and/or rental UI. Benefits can be provided to the customers by tailoring flows so that they are more likely to select a vehicle that is a good match for their lifestyle. This can be partly achieved by defaulting the car model/version to the car model/version that the customer is most likely to want—if that can be determined.

Benefits can also be provided to the environment by encouraging users to buy electric vehicles (EVs), especially if it looks like they can afford one, and they live in places that are friendly to EVs by having a lot of charging stations, and/or by having government discounts, rebates, and/or lots of car-pool lanes allowing EVs in their geographic location. This provides benefits to vehicle manufacturers as well through preferred sales.

Altering and customizing a user's UI flow based on their categorization/attributes is not a new idea. But existing methods and systems can be improved. Specifically, one idea is to factor in their past behavior clicking around and selecting things in the UI if they have used the UI before. This is not market-specific and could be generally applied across different markets/countries. Note: The terms “user” and “customer” are used interchangeably within this document.

The present background is provided as illustrative context only and should not be construed to be limiting in any manner. It will be readily apparent to those of ordinary skill in the art that the principles and concepts of the present disclosure may be implemented in other contexts equally, without limitation.

### SUMMARY

The main idea is to find ways to optimize the user experience such that customers/users who are online looking to purchase or lease/subscribe/rent vehicles are presented UI/UX user flows defaulting to or otherwise favoring the vehicle model/version (and trim and color and add-ons) that are as optimal as possible for both the user and for the vehicle manufacturer. These concepts may be extended beyond the automotive context as well.

In one illustrative embodiment, the present disclosure provides a dynamic user interface optimization system, including: an identification module executed by a processor and configured to one or more of: receive and store in a memory a user or device identification associated with a first product configuration and selection session of a user on a user interface of a display of a device, and determine and store in the memory user or device identification information associated with the first product configuration and selection session of the user; a pattern recognition module executed by the processor and configured to determine and store in the memory pattern information associated with the first product configuration and selection session of the user; and a dynamic suggestion module executed by the processor and configured to associate a second product configuration and selection session of the user on the user interface of the display of the device or a user interface of a display of another device based on any of the user or device identification, the user or device identification information and the pattern information stored in the memory and customize the second product configuration and selection session of the user accordingly. The dynamic user interface optimization system further includes a product preference module executed by the processor and configured to customize either or both of the first product configuration and selection session of the user and the second product configuration and selection session of the user based on a consideration not directly associated with the user. The consideration includes one or more of: a financial consideration associated with a manufacturer or seller, an environmental concern, an inventory consideration associated with the manufacturer or seller, and a safety consideration. The user or device identification information includes one or more of geographical information, day, time, product selection, and product configuration. The user or device identification information includes desired product availability date. The user or device identification information includes user interface modifications from default. The pattern information includes one or more or pages visited, page order, selections made, selection order, page combinations, selection combinations, page view time, hover time, page view speed, selection speed, and eye gaze direction.

In another illustrative embodiment, the present disclosure provides a dynamic user interface optimization method, including: using an identification module executed by a processor, one or more of: receive and store in a memory a user or device identification associated with a first product configuration and selection session of a user on a user interface of a display of a device, and determine and store in the memory user or device identification information associated with the first product configuration and selection session of the user; using a pattern recognition module executed by the processor, determine and store in the memory pattern information associated with the first product configuration and selection session of the user; and using a dynamic suggestion module executed by the processor, associate a second product configuration and selection session of the user on the user interface of the display of the device or a user interface of a display of another device based on any of the user or device identification, the user or device identification information and the pattern information stored in the memory and customize the second product configuration and selection session of the user accordingly. The dynamic user interface optimization method further includes, using a product preference module executed by the processor, customize either or both of the first product configuration and selection session of the user and the second product configuration and selection session of the user based on a consideration not directly associated with the user. The consideration includes one or more of: a financial consideration associated with a manufacturer or seller, an environmental concern, an inventory consideration associated with the manufacturer or seller, and a safety consideration. The user or device identification information includes one or more of geographical information, day, time, product selection, and product configuration. The user or device identification information includes desired product availability date. The user or device identification information includes user interface modifications from default. The pattern information includes one or more or pages visited, page order, selections made, selection order, page combinations, selection combinations, page view time, hover time, page view speed, selection speed, and eye gaze direction.

In a further illustrative embodiment, the present disclosure provides a non-transitory computer readable medium including instructions stored in a memory and executed by a processor to carry out the steps including: using an identification module executed by a processor, one or more of: receive and store in a memory a user or device identification associated with a first product configuration and selection session of a user on a user interface of a display of a device, and determine and store in the memory user or device identification information associated with the first product configuration and selection session of the user; using a pattern recognition module executed by the processor, determine and store in the memory pattern information associated with the first product configuration and selection session of the user; and using a dynamic suggestion module executed by the processor, associate a second product configuration and selection session of the user on the user interface of the display of the device or a user interface of a display of another device based on any of the user or device identification, the user or device identification information and the pattern information stored in the memory and customize the second product configuration and selection session of the user accordingly. The steps further include, using a product preference module executed by the processor, customize either or both of the first product configuration and selection session of the user and the second product configuration and selection session of the user based on a consideration not directly associated with the user. The user or device identification information includes one or more of geographical information, day, time, product selection, and product configuration. The user or device identification information includes desired product availability date. The user or device identification information includes user interface modifications from default. The pattern information includes one or more or pages visited, page order, selections made, selection order, page combinations, selection combinations, page view time, hover time, page view speed, selection speed, and eye gaze direction.

### BRIEF DESCRIPTION OF THE DRAWINGS

The present disclosure is illustrated and described herein with reference to the various drawings, in which:

FIG. 1 shows how initially the user is given multiple cars to select from to get started;

FIG. 2 shows how after a user has clicked on the “VIEW ALL FEATURES” button in FIG. 1, they are shown even more information about this car model;

FIG. 3 shows this user has an even more heightened level of interest in this car model than a user who has not clicked through to this level;

FIG. 4 shows a separate page where the user fills in their user details (after selecting a specific car they are most interested in—which is shown on the right);

FIG. 5 is a continuation of FIG. 4;

FIG. 6 is a network diagram of a cloud-based system for implementing the various algorithms and services of the present disclosure;

FIG. 7 is a block diagram of a server that may be used in the cloud-based system of FIG. 6 or stand-alone;

FIG. 8 is a block diagram of a user device that may be used in the cloud-based system of FIG. 6 or stand-alone; and

FIG. 9 is a schematic diagram illustrating one embodiment of the operation of one embodiment of the non-transitory computer readable medium of the present disclosure in presenting and modifying a user interface presented to a user.

### DETAILED DESCRIPTION

By way of example, assume most customers like an economy car model with the most basic version of that car model with no extras such as a fancy trim or add-ons. Then the optimal UI/UX user flow for most customers (or for all customers in general assuming the UI/UX flow is common across users) would be to show the most basic version of that car model with no extras such as a fancy trim or add-ons as the default or featured view or selection as the user navigates through the UI. That way on average they would not have to alter selections too much or scan around the UI pages much to find the car model and version they are most likely to want to select.

Assume for sake of discussion that it is in the vehicle manufacturer's best interest to have users choose the highest priced luxury car model/version, and to present in the UI/UX the most opportunities for the users to also choose fancy trim and add-ons. That assumes that presenting or featuring the luxury car model/version prominently in the UI would increase the users' likelihood of choosing those car models/versions. In reality, price/revenue is not always the highest priority. But this can annoy users since they must search around the UI a lot and change default selections a lot and this leads to a bad UI/UX experience, and this also leads to a lower sales conversion rate. So the two goals of having an optimal UI/UX user flow for most customers and having an optimal UI/UX user flow for the vehicle manufacturer are generally at odds with each other. Optimizing for one generally hurts the other. The methods described herein mitigate that by trying to optimize for both the users and the manufacturer.

There are many types of things that can be optimized for the manufacturer. Some of these can also be considered to a degree as also being an optimization for the users. One example is considering if the car in stock already now, and/or is the manufacturing time reduced by selection of certain car models/versions/trim. It frequently is months, sometimes even 6-8 months, that the user must wait before acquiring the car that they configured/ordered online. This is annoying to customers, and it also is bad for the manufacturer since the customers must wait a long time to make the sale. And this lengthy time increases the odds that the customers will get impatient and cancel their orders, and perhaps buy from a competitor.

Another optimization which is good for the manufacturer is to optimize the sales of EVs. These are better for the environment and can improve a manufacturer's reputation since the sales of EVs are heavily tracked/publicized, and it looks very positive for a manufacturer to be selling a large percentage of EVs. It makes a manufacturer appear very leading-edge and can even have positive political/business or regulatory implications.

Another optimization which is good for the manufacturer is to optimize the sales of the safest car models/versions. This could indirectly make a manufacturer's already strong reputation for safety even stronger if users buy more of the safest car models/versions.

Another optimization which is good for the manufacturer is to optimize the sales of the car models/versions that utilize the parts and supplies that are most readily available. This is especially important these days when supply chains can be strained due to COVID and/or war. Another optimization which is good for the manufacturer and for the customer is to explicitly recommend the soonest available car. That is, in addition to or instead of positioning a certain car more prominently in the UI, one could explicitly inform the user about the implications of one model or feature of a car compared to another. One example is if there is a worldwide shortage of yellow paint and a big supply of red paint, one could explicitly inform the user something like: “If you want the yellow car it'll take two months, but if you get a red car it'll take two weeks.” In order to do this, one could actually have a recommendation engine that factors in what are the materials needed, the materials available, and the materials already allocated for other existing car orders that have not been built yet.

Another optimization which is good for the manufacturer is to optimize their revenue and/or profitability.

It can be difficult to identify users of an online automotive ordering system, since sometimes they are allowed to choose the car before they must “identify” themselves by having some type of an ID or account, and/or by filling in all their personally identifiable information. A user logged in with an ID is so identified. If a user is identified, one might or might not have access to any of their previously completed orders, if they have any. If available, then one can make strategic UI/UX flow changes based on optimizing the UI/UX flow for both the user and the manufacturer.

If one has the user's ID, one can optimize the UI/UX flow based on some of the user's details. For example, their age, income, location, zip code, etc.

If one does not have the user's ID, one could optimize the UI/UX flow based on some of the user's country/market and/or language setting, and/or based on whether they are accessing the application from a certain browser type, and/or based on whether it is coming from a Windows user, a Mac, or a certain kind of mobile device. One could also keep track of a user's IP address and use that as a “key” to keep track of what kind or car model/version the user previously was looking at in the UI, even if they never proceeded to making an order/sale.

A unique way to optimize a user's and manufacturer's experience is to track and save information from a previous browser session for what appears to be this same user. For example, let's say on Monday a user comes to the site and one can tell it is from IP address 9.113.45.90. Let's say that the user never identifies themselves with their personal details, nor logs in with an ID. One could, within the UI, keep track of exactly what car model/version this user is looking at within the UI based on dropdown selections and/or which pages are visited and/or which car images are presented and/or manipulated within the UI, and/or based on what tooltip they hover over, etc. The UI could even track for how many seconds the user appears to view or do certain activity for a car model/version. The UI could send a variety of information describing the user's behavior and apparent car model/version preferences to the backend to be stored in a database, possibly using the IP address as a key. Or the ID can be a key, but the same kind of information can be stored. The ID and IP address could even be linked to effectively be used as the same key if there is value in that. Or the user's name can be a key. Or the user's physical address can be a key.

Again, suppose a user comes to the website on Monday. Then, say, two days later, on Wednesday, the user is detected as being the same user and they access the application again. This time, one could detect that this user had visited the website just two days before, even though they did not make a purchase. The backend could send information to the UI frontend denoting, for example, that the user the last time (on Monday) was spending time looking at a red high-end EV sport-utility vehicle (SUV) with a certain trim added. Then on Wednesday the backend can detect it is the same user and inform the UI to present as the initial car view for the user to see a red high-end EV SUV with a certain trim added, instead of the usual defaults. This is an optimized experience for both the user and the manufacturer and would presumably lead to better sales and better user satisfaction.

Another optimization would be to dynamically change the default order of vehicles to show based on settings in a database table (or similar technology) that dynamically update. The settings could be dynamically updated based upon inventory, supply chain issues, or even gasoline prices (based on mpg).

Users are typically assigned to a dealer based primarily upon location—by default they are assigned to the closest dealer, but that can be overridden. Another optimization is, when and if one knows what car dealership the user is assigned to, to dynamically adjust the vehicles shown to the user in which order in the UI based upon the inventory of that specific dealer. Other dealer-specific attributes could be factored in as well, including what vehicles that dealer has on display at their site, or just based on some stated dealer preferences. Another optimization could be specific to EVs. If the user is in a state or location that is more EV-friendly, then we could make the relative priority of EVs higher. (EV-friendliness could be based on the prevalence of chargers, the existence of government rebates or tax incentives for EVs or based on the percentage of EVs that are owned in this state or area compared to other states or locations). Also, if the user has been known to look at any EV within the UI, then the algorithms could be adjusted to elevate the priority or order of all EVs to be displayed for this user. And especially if the user has clicked on or selected any add-on or feature specific to charging or that is otherwise EV-specific one could capture that information, send it back to the server, and conclude that this user is very interested in EVs. Another optimization is to pick a nearby dealer in a location with lower taxes and fees (for example if he customer is near the border of another state with lower taxes).

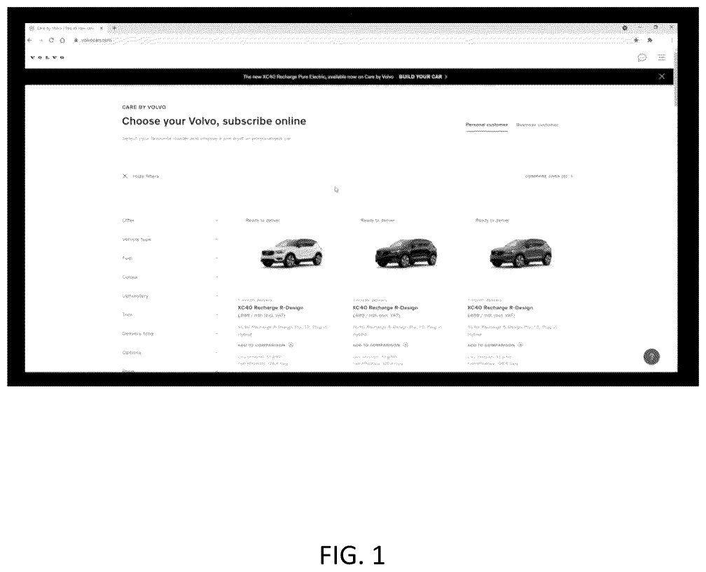

As an example UI flow illustration, FIG. 1 shows how initially the user is given multiple cars to select from to get started. This is a limited example it shows 3 cars with the same model/version and only the color is different—but assume it is showing three totally distinct cars models—and some are EVs and some are not. This shows that once the user clicks on a specific car model, the site shows more information (and a button called “VIEW ALL FEATURES”).

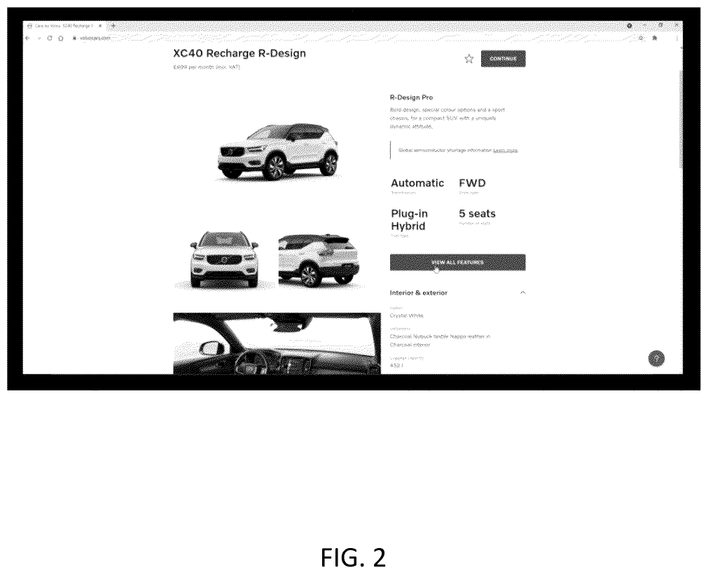

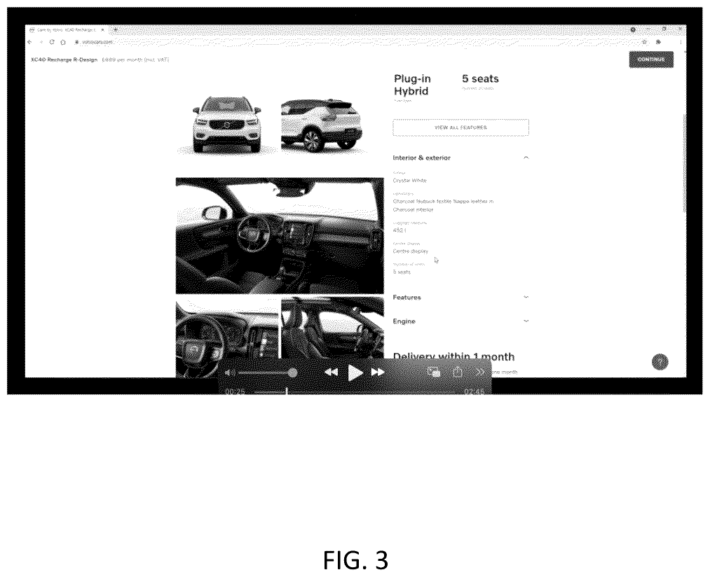

FIG. 2 shows how after a user has clicked on the “VIEW ALL FEATURES” button in FIG. 1, they are shown even more information about this car model. FIG. 3 shows this user has an even more heightened level of interest in this car model than a user who has not clicked through to this level. This heightened level of interest in this car model by the user can be captured in the front-end (UI) code and sent to the backend to be stored for later use.

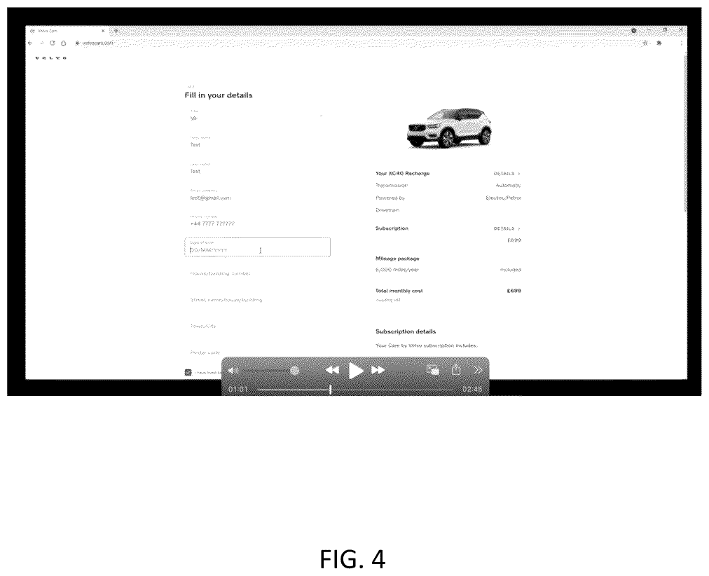

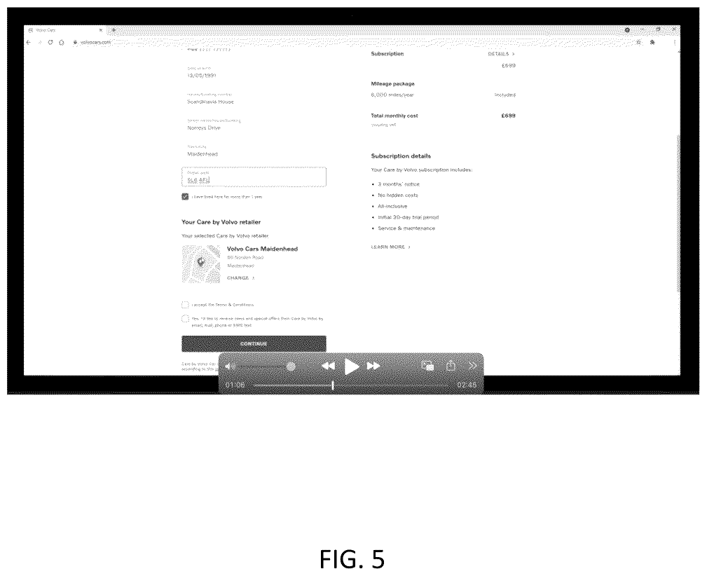

FIG. 4 shows a separate page where the user fills in their user details (after selecting a specific car they are most interested in—which is shown on the right). FIG. 5 is a continuation of the previous page/screen. This shows how after the user fills in their zip code/postal code (the final part of their address) a car dealer is selected by default—the closest dealership to their address location. They can then change the dealer if they want. This is just one example of how the dealer can be selected.

A code can be provided in the UI to keep track of what vehicles/models/trim/options have been viewed by the customer—aside from the default initial views. Generally, a UI just sends to the backend server the final selections of a customer. But one could add a technique on the UI frontend to keep track of which pages/cars/etc. were explicitly selected and viewed by a user. The UI could even keep track of and send to the backend server how many seconds the user spent looking at this or that option or car model or image, etc., before moving on or switching to another view. This data can be stored and used to show the user an initial default vehicle selected in the UI the same car model/version as they last looked at, or that they looked at the longest. Or there could be a formula that compromises between the above and the car models/versions that are deemed most desirable. Companies use this data to track overall summarized user behavior for user research but using it to feed into decision programmatically for a single user is a new concept).

It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

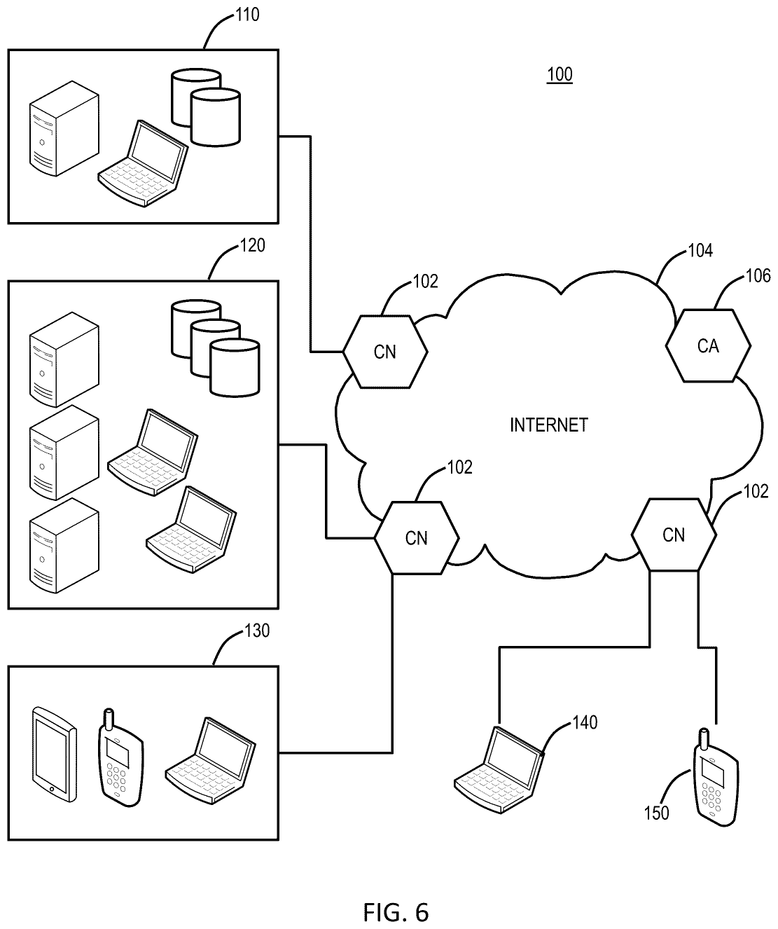

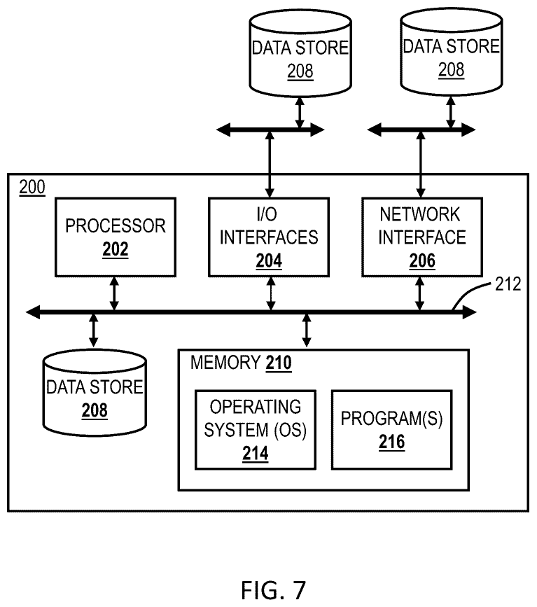

FIG. 6 is a network diagram of a cloud-based system 100 for implementing various cloud-based services of the present disclosure. The cloud-based system 100 includes one or more cloud nodes (CNs) 102 communicatively coupled to the Internet 104 or the like. The cloud nodes 102 may be implemented as a server 200 (as illustrated in FIG. 7) or the like and can be geographically diverse from one another, such as located at various data centers around the country or globe. Further, the cloud-based system 100 can include one or more central authority (CA) nodes 106, which similarly can be implemented as the server 200 and be connected to the CNs 102. For illustration purposes, the cloud-based system 100 can connect to a regional office 110, headquarters 120, various employee's homes 130, laptops/desktops 140, and mobile devices 150, each of which can be communicatively coupled to one of the CNs 102. These locations 110, 120, and 130, and devices 140 and 150 are shown for illustrative purposes, and those skilled in the art will recognize there are various access scenarios to the cloud-based system 100, all of which are contemplated herein. The devices 140 and 150 can be so-called road warriors, i.e., users off-site, on-the-road, etc. The cloud-based system 100 can be a private cloud, a public cloud, a combination of a private cloud and a public cloud (hybrid cloud), or the like.

Again, the cloud-based system 100 can provide any functionality through services, such as software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the locations 110, 120, and 130 and devices 140 and 150. Previously, the Information Technology (IT) deployment model included enterprise resources and applications stored within an enterprise network (i.e., physical devices), behind a firewall, accessible by employees on site or remote via Virtual Private Networks (VPNs), etc. The cloud-based system 100 is replacing the conventional deployment model. The cloud-based system 100 can be used to implement these services in the cloud without requiring the physical devices and management thereof by enterprise IT administrators.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “software as a service” (SaaS) is sometimes used to describe application programs offered through cloud computing. A common shorthand for a provided cloud computing service (or even an aggregation of all existing cloud services) is “the cloud.” The cloud-based system 100 is illustrated herein as one example embodiment of a cloud-based system, and those of ordinary skill in the art will recognize the systems and methods described herein are not necessarily limited thereby.

FIG. 7 is a block diagram of a server 200, which may be used in the cloud-based system 100 (FIG. 6), in other systems, or stand-alone. For example, the CNs 102 (FIG. 6) and the central authority nodes 106 (FIG. 6) may be formed as one or more of the servers 200. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 6 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but is not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a central processing unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104 (FIG. 6). The network interface 206 may include, for example, an Ethernet card or adapter (e.g., 10BaseT, Fast Ethernet, Gigabit Ethernet, or 10 GbE) or a Wireless Local Area Network (WLAN) card or adapter (e.g., 802.11a/b/g/n/ac). The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., a SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable operating system (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable medium having computer-readable code stored thereon for programming a computer, server, appliance, device, processor, circuit, etc. each of which may include a processor to perform functions as described and claimed herein. Examples of such computer-readable mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

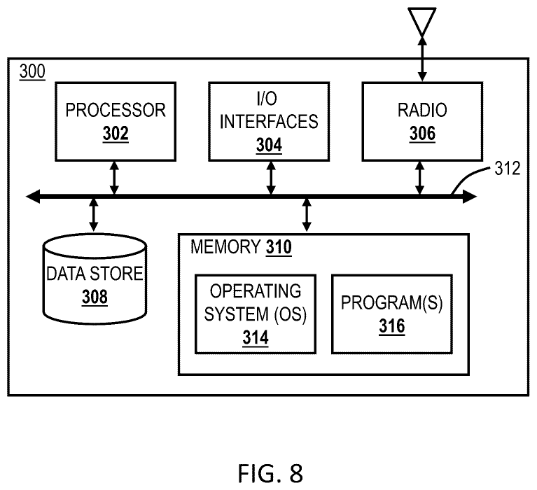

FIG. 8 is a block diagram of a user device 300, which may be used in the cloud-based system 100 (FIG. 6), as part of a network, or stand-alone. Again, the user device 300 can be a vehicle, a smartphone, a tablet, a smartwatch, an Internet of Things (IOT) device, a laptop, a virtual reality (VR) headset, etc. The user device 300 can be a digital device that, in terms of hardware architecture, generally includes a processor 302, I/O interfaces 304, a radio 306, a data store 308, and memory 310. It should be appreciated by those of ordinary skill in the art that FIG. 7 depicts the user device 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 can be, for example, but is not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the user device 300, a semiconductor-based microprocessor (in the form of a microchip or chipset), or generally any device for executing software instructions. When the user device 300 is in operation, the processor 302 is configured to execute software stored within the memory 310, to communicate data to and from the memory 310, and to generally control operations of the user device 300 pursuant to the software instructions. In an embodiment, the processor 302 may include a mobile optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a liquid crystal display (LCD), touch screen, and the like.

The radio 306 enables wireless communication to an external access device or network. Any number of suitable wireless data communication protocols, techniques, or methodologies can be supported by the radio 306, including any protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

Again, the memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 8, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end user functionality with the user device 300. For example, example programs 316 may include, but not limited to, a web browser, social networking applications, streaming media applications, games, mapping and location applications, electronic mail applications, financial applications, and the like. In a typical example, the end-user typically uses one or more of the programs 316 along with a network, such as the cloud-based system 100 (FIG. 6).

Again, the present disclosure provides a system and method for removing noise from an ultrasonic signal using a GAN. GANs have been shown to perform well in removing noise from images in a variety of contexts, providing sharper images. In general, a GAN is a DNN, such as a CNN, that, in an unsupervised ML operation, involves automatically discovering and learning patterns in input data such that the resulting model can be used to generate output that plausibly could have been resulted from the original dataset. The GAN frames a problem as a supervised learning problem with two sub-models: a generator model that generates new examples and a discriminator model that classifies examples as either real (i.e., from the domain) or fake (i.e., generated). The two models are trained together in an adversarial manner until the discriminator model is fooled about half the time, meaning the generator model is generating plausible examples. Such GANs are well known to those of ordinary skill in the art, but have not yet been applied to ultrasonic sensor noise removal. The present disclosure provides three input formats for the NN in order to feed 1D input data to the network. The system is generalizable to multiple noise sources, as it learns from different motion functions and noise types. The end-to-end system of the present disclosure is trained on raw ultrasonic signals with very little pre-processing or feature extraction.

Other functionalities contemplated herein include monitoring where on a page a user clicks as well as their click speed to try to characterize the user for subsequent vehicle preferencing. Gaze direction on a page can also be monitored and utilized using a camera in a vehicle or virtual reality (VR)-based system, or even a mobile device-based system. A multitude of similar other factors may be considered as well.

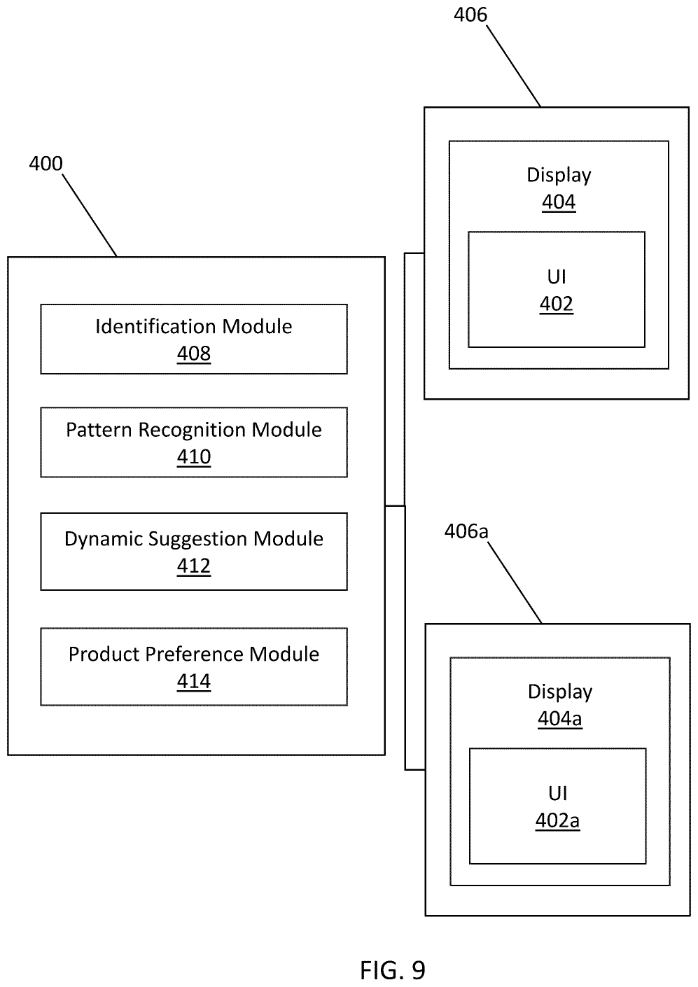

Referring now to FIG. 9, using a method implemented as non-transitory computer readable medium steps and instructions stored in a memory and executed via a processor, the dynamic user interface system 400 of the present disclosure includes a UI 402, such as a webpage or mobile device UI, presented to a user on a display 404 of a device 406 by which vehicles or the like are presented, configured, and selected. The user is able to meaningfully interact with this UI 402. The system 400 includes an identification module 408 that is configured to receive or determine a user or device ID in the event that is received or able to be determined during an initial session. In the event that a user or device ID is not received or able to be determined during the initial session, the identification module 408 is configured to tag the initial session with identification information, such as geographical location, day, time, etc. The system 400 also includes a pattern recognition module 410 that is configured to recognize and store patterns related to the user's interaction with the UI 402, such as pages visited, selections made, selections patterns, entry speed, and the like. These recognized patterns act as a default user or device ID in the event that the user or device ID is not received or able to be determined, and provide possible preference information about the user. Data from the identification module 408 and the pattern recognition module 410 is automatically stored in a server and memory remote from the device 406.

In the event that the user terminates a vehicle or other configuration session without finalizing a vehicle selection and purchase, but returns later during a subsequent session, the presentment of available vehicles and vehicle configurations and the like is automatically tailored via a dynamic suggestion module 412 using the stored data of the identification module 408 and the pattern recognition module 410, generating an appropriate subsequent UI 402a presented to the user on the same or another display 404a of the same or another device 406a. For example, if the user or device ID is again received, then the dynamic suggestion module 412 may tailor the vehicles and vehicle configurations or the like presented based on information associated with the original user or device ID received in the original session. If the user or device ID is again not received, then the dynamic suggestion module 412 may tailor the vehicles and vehicle configurations or the like presented based on information associated with a matching original session based on data stored from the identification module 408 and/or the pattern recognition module 410, such as geographic location, day, time, pages visited, selections made, selections patterns, entry speed, and the like. In this manner, the system 400 can attempt to match a current user session with a past user session to make targeted vehicle and vehicle configuration suggestions and the like. The more sessions available for a given user, and the more targeted these sessions are, the more likely the system 400 is to make appropriate suggestions in subsequent UIs.

As alluded to above, the system 400 may also include a product preference module 414 that is designed to select and “push” products that are preferred to due financial considerations, environmental concerns, inventory considerations, etc.

Although the present disclosure is illustrated and described herein with reference to illustrative embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. A dynamic user interface optimization system, comprising:
an identification module executed by a processor and configured to one or more of:
receive and store in a memory a user or device identification associated with a first product configuration and selection session of a user on a user interface of a display of a device, and
determine and store in the memory user or device identification information associated with the first product configuration and selection session of the user;
a pattern recognition module executed by the processor and configured to determine and store in the memory pattern information associated with the first product configuration and selection session of the user; and
a dynamic suggestion module executed by the processor and configured to associate a second product configuration and selection session of the user on the user interface of the display of the device or a user interface of a display of another device based on any of the user or device identification, the user or device identification information and the pattern information stored in the memory and customize the second product configuration and selection session of the user accordingly.

2. The dynamic user interface optimization system of claim 1, further comprising a product preference module executed by the processor and configured to customize either or both of the first product configuration and selection session of the user and the second product configuration and selection session of the user based on a consideration not directly associated with the user.

3. The dynamic user interface optimization system of claim 2, wherein the consideration comprises one or more of: a financial consideration associated with a manufacturer or seller, an environmental concern, an inventory consideration associated with the manufacturer or seller, and a safety consideration.

4. The dynamic user interface optimization system of claim 1, wherein the user or device identification information comprises one or more of geographical information, day, time, product selection, and product configuration.

5. The dynamic user interface optimization system of claim 1, wherein the user or device identification information comprises desired product availability date.

6. The dynamic user interface optimization system of claim 1, wherein the user or device identification information comprises user interface modifications from default.

7. The dynamic user interface optimization system of claim 1, wherein the pattern information comprises one or more or pages visited, page order, selections made, selection order, page combinations, selection combinations, page view time, hover time, page view speed, selection speed, and eye gaze direction.

8. A dynamic user interface optimization method, comprising:
using an identification module executed by a processor, one or more of:
receive and store in a memory a user or device identification associated with a first product configuration and selection session of a user on a user interface of a display of a device, and
determine and store in the memory user or device identification information associated with the first product configuration and selection session of the user;
using a pattern recognition module executed by the processor, determine and store in the memory pattern information associated with the first product configuration and selection session of the user; and
using a dynamic suggestion module executed by the processor, associate a second product configuration and selection session of the user on the user interface of the display of the device or a user interface of a display of another device based on any of the user or device identification, the user or device identification information and the pattern information stored in the memory and customize the second product configuration and selection session of the user accordingly.

9. The dynamic user interface optimization method of claim 8, further comprising, using a product preference module executed by the processor, customize either or both of the first product configuration and selection session of the user and the second product configuration and selection session of the user based on a consideration not directly associated with the user.

10. The dynamic user interface optimization method of claim 9, wherein the consideration comprises one or more of: a financial consideration associated with a manufacturer or seller, an environmental concern, an inventory consideration associated with the manufacturer or seller, and a safety consideration.

11. The dynamic user interface optimization method of claim 8, wherein the user or device identification information comprises one or more of geographical information, day, time, product selection, and product configuration.

12. The dynamic user interface optimization method of claim 8, wherein the user or device identification information comprises desired product availability date.

13. The dynamic user interface optimization method of claim 8, wherein the user or device identification information comprises user interface modifications from default.

14. The dynamic user interface optimization method of claim 8, wherein the pattern information comprises one or more or pages visited, page order, selections made, selection order, page combinations, selection combinations, page view time, hover time, page view speed, selection speed, and eye gaze direction.

15. A non-transitory computer readable medium comprising instructions stored in a memory and executed by a processor to carry out the steps comprising:
using an identification module executed by a processor, one or more of:
receive and store in a memory a user or device identification associated with a first product configuration and selection session of a user on a user interface of a display of a device, and
determine and store in the memory user or device identification information associated with the first product configuration and selection session of the user;
using a pattern recognition module executed by the processor, determine and store in the memory pattern information associated with the first product configuration and selection session of the user; and
using a dynamic suggestion module executed by the processor, associate a second product configuration and selection session of the user on the user interface of the display of the device or a user interface of a display of another device based on any of the user or device identification, the user or device identification information and the pattern information stored in the memory and customize the second product configuration and selection session of the user accordingly.

16. The non-transitory computer readable medium of claim 15, the steps further comprising, using a product preference module executed by the processor, customize either or both of the first product configuration and selection session of the user and the second product configuration and selection session of the user based on a consideration not directly associated with the user.

17. The non-transitory computer readable medium of claim 15, wherein the user or device identification information comprises one or more of geographical information, day, time, product selection, and product configuration.

18. The non-transitory computer readable medium of claim 15, wherein the user or device identification information comprises desired product availability date.

19. The non-transitory computer readable medium of claim 15, wherein the user or device identification information comprises user interface modifications from default.

20. The non-transitory computer readable medium of claim 15, wherein the pattern information comprises one or more or pages visited, page order, selections made, selection order, page combinations, selection combinations, page view time, hover time, page view speed, selection speed, and eye gaze direction.
